(19) United States
(12) Patent Application Publication
(10) Pub. No.: US 2019/0205819 A1
(43) Pub. Date: Jul. 4, 2019

(54) TRANSPORT SYSTEM AND TRANSPORT METHOD

(71) Applicant: Toyota Jidosha Kabushiki Kaisha, Toyota-shi Aichi-ken (JP)

(72) Inventors: Hiroshi Igata, Yokohama-shi (JP); Yuchi Yamanouchi, Toyota-shi (JP); Atsushi Sajiki, Okazaki-shi (JP); Hidenari Soya, Toyota-shi (JP); Satoshi Usui, Tokyo (JP)

(73) Assignee: Toyota Jidosha Kabushiki Kaisha, Toyota-shi Aichi-ken (JP)

(21) Appl. No.: 16/225,506

(22) Filed: Dec. 19, 2018

(30) Foreign Application Priority Data
Dec. 28, 2017 (JP) 2017-253755

(51) Int. Cl. G06Q 10/08; G05D 1/00; G07C 9/00

(52) U.S. Cl. CPC G06Q 10/083; G05D 1/0088; G07C 2009/0092; G07C 9/00896; G05D 2201/0216; G07C 9/00309

(57) ABSTRACT

A transport system includes an autonomous mobile unit and a management device. The management device includes a user interface unit configured to allow a client requesting transport of a package to specify a recipient and place of pickup of the package, a first move instruction transmission unit configured to transmit a move instruction containing the specified place of pickup as a destination to the autonomous mobile unit, a lock instruction transmission unit configured to, upon receiving lock request information transmitted by the client, transmit a lock instruction to the autonomous mobile unit, a second move instruction transmission unit configured to transmit the move instruction containing a place of receipt specified by the client or the recipient as a destination to the autonomous mobile unit, and an unlock instruction transmission unit configured to, upon receiving unlock request information transmitted by the recipient, transmit an unlock instruction to the autonomous mobile unit.

### CROSS-REFERENCE TO RELATED APPLICATIONS

This application claims priority to Japanese Patent Application No. 2017-253755 filed on Dec. 28, 2017, which is incorporated herein by reference in its entirety including the specification, drawings and abstract.

### BACKGROUND

### 1. Technical Field

The disclosure relates to a transport system and transport method.

### 2. Description of Related Art

A method of transferring a package between individuals includes a method in which a sender (consignor) of a package moves the package and hands the package to a recipient, a method in which a sender of a package makes a request of a home-delivery company to deliver the package, and a method in which a sender of a package uses a locker (for example, a transfer box that does not require an exchange of a physical key; see, for example, Japanese Unexamined Patent Application Publication No. 2003-020832 (JP 2003-020832 A)).

The method in which a sender of a package moves the package and hands the package to a recipient is difficult to be employed when the sender is not acquainted with the recipient (when the package is an article sold on an online auction, or the like) or when the package is heavy. When a sender of a package makes a request of a home-delivery company to deliver the package, it takes considerable time (for example, one day) for the package to reach a recipient. When a sender of a package transfers the package with the use of a locker, both the sender and a recipient are required to go to the locker.

### SUMMARY

The disclosure provides a transport system and a transport method that are able to realize an environment in which a package is easily transferred between individuals with ensured security.

A first aspect of the disclosure relates to a transport system. The transport system includes an autonomous mobile unit and a management device. The autonomous mobile unit includes a lockable and unlockable luggage compartment, a drive unit configured to move the autonomous mobile unit, a wireless communication unit configured to carry out wireless communication, and a control unit configured to communicate with another device via the wireless communication unit. The control unit is configured to, when the control unit has received a move instruction containing a specified destination from the management device, control the drive unit such that the autonomous mobile unit reaches the destination specified by the move instruction. The control unit is configured to, when the control unit has received a lock instruction from the management device, lock the luggage compartment. The control unit is configured to, when the control unit has received an unlock instruction from the management device, unlock the luggage compartment. The management device includes a user interface unit, a first move instruction transmission unit, a lock instruction transmission unit, a second move instruction transmission unit, and an unlock instruction transmission unit. The user interface unit is configured to allow a client requesting transport of a package to specify a recipient of the package and a place of pickup where pickup of the package is performed. The first move instruction transmission unit is configured to transmit the move instruction containing the place of pickup specified by the client as a destination to the autonomous mobile unit. The lock instruction transmission unit is configured to, when lock request information transmitted by the client has been received, transmit the lock instruction to the autonomous mobile unit. The second move instruction transmission unit is configured to transmit the move instruction containing a place of receipt where receipt of the package is performed specified by any one of the client and the recipient as a destination to the autonomous mobile unit. The unlock instruction transmission unit is configured to, when unlock request information transmitted by the recipient has been received, transmit the unlock instruction to the autonomous mobile unit.

That is, in this transport system (hereinafter, also referred to as first transport system), when a sender of a package (a client requesting transport of a package) specifies a desired place as a place of pickup, the autonomous mobile unit reaches the place of pickup. When the sender loads the package into the luggage compartment of the autonomous mobile unit that has arrived at the place of pickup and transmits lock request information with the use of a mobile terminal, or the like, the autonomous mobile unit moves to a place of receipt specified by any one of the sender and a recipient. During moving, the luggage compartment of the autonomous mobile unit is locked, and the first transport system (the control unit of the autonomous mobile unit and the unlock instruction transmission unit of the management device) releases locking of the luggage compartment (unlocks the luggage compartment) when the recipient has made an unlock request (when unlock request information transmitted by the recipient has been received). Therefore, with the first transport system, it is possible to realize an environment that, in a form that neither a problem, such as theft, replacement, and damage, occurs on a package nor a package is unloaded from the luggage compartment by a person other than a recipient during transport, a sender is allowed to ship a package at a desired place and the recipient is allowed to receive a package at a place of receipt specified by the sender or a place of receipt specified by the recipient (that is, an environment that a package is easily transferred between individuals in a form that security is ensured).

The second move instruction transmission unit of the management device of the first transport system may be configured to transmit the move instruction containing a place of receipt specified by the client as a destination to the autonomous mobile unit, or may be configured to transmit the move instruction containing a place of receipt specified by the recipient as a destination to the autonomous mobile unit. In the above configuration, for example, the user interface unit may be configured to allow the client of transport of the package to specify a recipient of the package, a place of pickup where pickup of the package is performed, and a place of receipt of the package. In the above configuration, the management device may additionally include a second user interface unit configured to allow the recipient to specify a place of receipt of the package.

A second aspect of the disclosure relates to a transport system. The transport system includes an autonomous mobile unit and a management device. The autonomous mobile unit includes a lockable and unlockable luggage compartment, a drive unit configured to move the autonomous mobile unit, a wireless communication unit configured to carry out wireless communication, an information input unit configured to receive input of information, and a control unit configured to communicate with another device via the wireless communication unit. The control unit is configured to, when the control unit has received a move instruction containing a specified destination from the management device, control the drive unit such that the autonomous mobile unit reaches the destination specified by the move instruction. The control unit is configured to, when the control unit determines that loading of a package into the luggage compartment has been completed, lock the luggage compartment and transmit lock release information to the management device. The control unit is configured to, when the lock release information has been input to the information input unit, unlock the luggage compartment. The management device includes a user interface unit, a first move instruction transmission unit, and a second move instruction transmission unit. The user interface unit is configured to allow a client requesting transport of the package to specify a recipient of the package and a place of pickup where pickup of the package is performed. The first move instruction transmission unit is configured to transmit the move instruction containing the place of pickup specified by the client as a destination to the autonomous mobile unit. The second move instruction transmission unit is configured to, after the lock release information has been received from the autonomous mobile unit, provide the lock release information to the recipient, and transmit the move instruction containing a place of receipt where receipt of the package is performed specified by any one of the client and the recipient as a destination to the autonomous mobile unit.

That is, in this transport system (hereinafter, also referred to as second transport system), when a sender of a package (a client requesting transport of a package) specifies a desired place as a place of pickup, the autonomous mobile unit reaches the place of pickup. When the sender loads the package into the luggage compartment of the autonomous mobile unit that has arrived at the place of pickup and the control unit of the autonomous mobile unit determines that loading of the package into the luggage compartment has been completed, the autonomous mobile unit moves to a place of receipt specified by any one of the sender and a recipient. During moving, the luggage compartment of the autonomous mobile unit is locked, and the second transport system (the control unit of the autonomous mobile unit) releases locking of the luggage compartment when lock release information provided to the recipient has been input to the information input unit. Therefore, with the second transport system as well, it is possible to realize an environment that a package is transferred between individuals in a form that security is ensured.

A third aspect of the disclosure relates to a transport system. The transport system includes an autonomous mobile unit and a management device. The autonomous mobile unit includes a lockable and unlockable luggage compartment, a drive unit configured to move the autonomous mobile unit, a wireless communication unit configured to carry out wireless communication, an information input unit configured to receive input of information, and a control unit configured to communicate with another device via the wireless communication unit. The control unit includes a storage unit for storing lock release information. The control unit is configured to, when the control unit has received a move instruction containing a specified destination from the management device, control the drive unit such that the autonomous mobile unit reaches the destination specified by the move instruction. The control unit is configured to, when the control unit determines that loading of a package into the luggage compartment has been completed, lock the luggage compartment. The control unit is configured to, when the same information as the lock release information in the storage unit has been input to the information input unit, unlock the luggage compartment. The control unit is configured to, when the control unit has received a predetermined lock release information update instruction from the management device, update first lock release information included in the lock release information in the storage unit with second lock release information included in the predetermined lock release information update instruction and included in the lock release information. The management device includes an update instruction unit, a user interface unit, a first move instruction transmission unit, and a second move instruction transmission unit. The update instruction unit is configured to generate the second lock release information and transmit the lock release information update instruction, containing the second lock release information, to the autonomous mobile unit. The user interface unit is configured to allow a client requesting transport of the package to specify a recipient of the package and a place of pickup where pickup of the package is performed. The first move instruction transmission unit is configured to transmit the move instruction containing the place of pickup specified by the client as a destination to the autonomous mobile unit. The second move instruction transmission unit is configured to provide the latest second lock release information generated by the update instruction unit to the recipient, and transmit the move instruction containing a place of receipt where receipt of the package is performed specified by any one of the client and the recipient as a destination to the autonomous mobile unit.

That is, this transport system (hereinafter, also referred to as third transport system) is modified from the second transport system such that lock release information is generated by the management device. Therefore, with the third transport system as well, it is possible to realize an environment that a package is transferred between individuals in a form that security is ensured. The update instruction unit of the management device of the third transport system may be, for example, configured to, each time lock release information is provided to the recipient, generate new lock release information and transmit the lock release information update instruction containing the generated lock release information to the autonomous mobile unit.

The second move instruction transmission unit of the management device of each of the second and third transport systems may also be configured to transmit the move instruction containing a place of receipt specified by the client as a destination to the autonomous mobile unit, or may be configured to transmit the move instruction containing a place of receipt specified by the recipient as a destination to the autonomous mobile unit. The information input unit of the autonomous mobile unit of each of the second and third transport systems may be configured to allow the recipient to directly input lock release information (such as a unit including a plurality of switches for inputting lock release information), or may be configured to allow the recipient to input lock release information by operating a mobile terminal, such as a smart phone (such as a unit that carries out wireless data communication by infrared rays or radio waves). The procedure by which the control unit determines whether loading of a package into the luggage compartment has been completed is also not specifically limited. For example, the control unit may be configured to, when a door of the luggage compartment has been once opened and then closed, determine that loading of the package has been completed. The control unit may be configured to, when predetermined information has been input to the information input unit, determine that loading of the package into the luggage compartment has been completed.

A fourth aspect of the disclosure relates to a transport method. The transport method is used to cause an autonomous mobile unit, including an electrically lockable and unlockable luggage compartment, to transport a package. The transport method includes allowing, by one or more computers, a client requesting transport of the package by the autonomous mobile unit to specify a recipient of the package and a place of pickup where pickup of the package is performed; moving, by the one or more computers, the autonomous mobile unit to the place of pickup specified by the client; when it is determined that loading of the package into the luggage compartment of the autonomous mobile unit moved to the place of pickup has been completed, locking, by the one or more computers, the luggage compartment; moving, by the one or more computers, the autonomous mobile unit of which the luggage compartment has been locked to a place of receipt where receipt of the package is performed specified by any one of the client and the recipient; and, when an unlock instruction has been input by the recipient, unlocking, by the one or more computers, the luggage compartment of the autonomous mobile unit moved to the place of receipt.

Therefore, with this transport method as well, it is possible to realize an environment that a package is transferred between individuals in a form that security is ensured.

In the above-described transport method, the autonomous mobile unit may be moved to the place of receipt specified by the client or may be moved to the place of receipt specified by the recipient. In the transport method, it may be determined that loading of the package into the luggage compartment has been completed when a door of the luggage compartment has been once opened and then closed, or it may be determined that loading of the package into the luggage compartment has been completed when a lock instruction has been input by the client.

With the transport system and transport method according to the aspects of the disclosure, it is possible to realize an environment that a package is easily transferred between individuals in a form that security is ensured.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of a transport system according to a first embodiment;

FIG. 2 is a schematic configuration diagram of an autonomous mobile unit of the transport system according to the first embodiment;

FIG. 3 is a view that illustrates a request management DB provided in a management device of the transport system according to the first embodiment;

FIG. 4 is a sequence diagram for illustrating the operations of the transport system according to the first embodiment in the case where a place of receipt is specified by a sender;

FIG. 5 is a sequence diagram for illustrating the operations of the transport system according to the first embodiment in the case where a place of receipt is not specified by a sender;

FIG. 6 is a sequence diagram for illustrating the operations of the transport system according to the first embodiment in the case where a place of receipt is not specified by a sender;

FIG. 7 is a schematic configuration diagram of an autonomous mobile unit of a transport system according to a second embodiment; and

FIG. 8 is a sequence diagram for illustrating the operations of the transport system according to the second embodiment in the case where a place of receipt is specified by a sender.

### DETAILED DESCRIPTION OF EMBODIMENTS

Hereinafter, embodiments of the disclosure will be described with reference to the accompanying drawings.

### First Embodiment

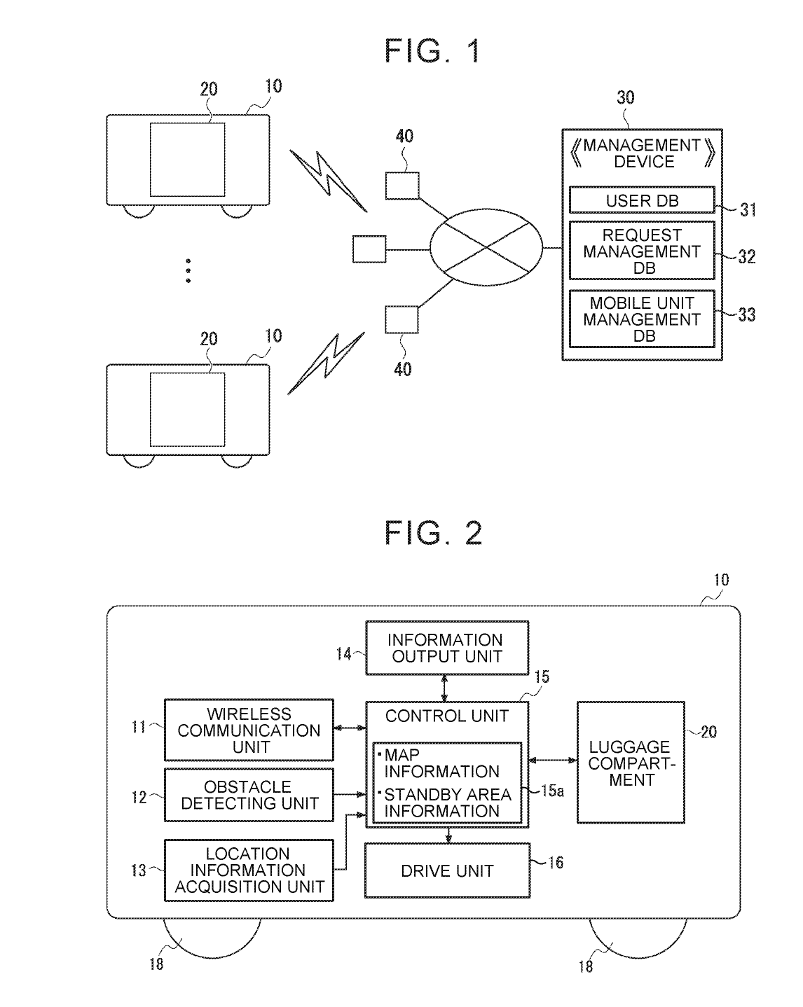

FIG. 1 shows the schematic configuration of a transport system according to a first embodiment of the disclosure. As shown in the drawing, the transport system according to the present embodiment includes a plurality of autonomous mobile units 10 and a management device 30.

Initially, the configuration and functions of each of the autonomous mobile units 10 will be described. FIG. 2 shows the schematic configuration of each autonomous mobile unit 10. As shown in the drawing, each autonomous mobile unit 10 includes a wireless communication unit 11, an obstacle detecting unit 12, a location information acquisition unit 13, an information output unit 14, a control unit 15, a drive unit 16, wheels 18, and a luggage compartment 20.

The drive unit 16 is a unit for moving the autonomous mobile unit 10. The drive unit 16 includes, for example, a motor for rotating the wheels 18, an inverter that drives the motor, a steering mechanism for controlling (changing) the traveling direction of the autonomous mobile unit 10, a secondary battery, and the like.

The wireless communication unit 11 is a unit for carrying out communication (information exchange) with the management device 30 via an access point 40 or a base station 40 through wireless communication that conforms with standards, such as Wi-Fi, 4G, and LTE. The obstacle detecting unit 12 is a unit for detecting an obstacle around the autonomous mobile unit 10. Examples of the obstacle detecting unit 12 include a stereo camera, RADAR, laser imaging detection and ranging (LIDAR), and a unit including a combination of any two or more of them.

The location information acquisition unit 13 is a unit that acquires (holds) the current location of the autonomous mobile unit 10. A unit that corrects a location identified by a global positioning system (GPS) receiver based on, for example, a surrounding situation detected by the obstacle detecting unit 12 and outputs the location or a unit that calculates a current location by integrating the amounts of movement of the autonomous mobile unit 10 in X and Y directions may be employed as the location information acquisition unit 13.

The information output unit 14 is a unit that outputs information to be provided to a user (in the present embodiment, a liquid crystal display). The luggage compartment 20 is a storage for a package. The control unit 15 is able to lock or unlock the luggage compartment 20.

The control unit 15 includes a CPU (not shown), a RAM (not shown), a nonvolatile memory 15a, and the like. The control unit 15 is a unit that controls the information output unit 14, the drive unit 16, and the luggage compartment 20.

Map information, standby area information, traveling route information (not shown), programs (not shown) that the CPU executes, and the like, are stored in the nonvolatile memory 15a of the control unit 15. The map information is information (for example, three-dimensional map information) that the control unit 15 (the control unit 15 of which the CPU is executing a program by loading the program from the nonvolatile memory 15a onto the RAM) consults in order to determine a route to a destination. The standby area information is information that specifies the location (coordinate range) of one or more standby areas (details will be described later). The traveling route information is information that specifies a traveling route of the autonomous mobile unit 10 during normal times (when the autonomous mobile unit 10 is not used to handle a transport request to transport a package).

Hereinafter, the details of control that is executed by the control unit 15 of the autonomous mobile unit 10 will be specifically described.

The control unit 15 is configured (programmed) to periodically transmit the current location to the management device 30. When no transport request is assigned to the autonomous mobile unit 10, the control unit 15 controls the drive unit 16 such that the autonomous mobile unit 10 travels along a route specified by traveling route information in a state where the luggage compartment 20 is locked.

Instructions that the management device 30 provides to the control unit 15 include a move instruction, a lock instruction, an unlock instruction, an information output instruction, an information output stop instruction, and a return instruction.

The move instruction includes information that specifies a destination. When the control unit 15 has received a move instruction, the control unit 15 controls the drive unit 16 such that the autonomous mobile unit 10 reaches the destination specified by the move instruction. At this time, the control unit 15 determines a route to the destination by using obstacles detected by the obstacle detecting unit 12, and the map information, and moves the autonomous mobile unit 10 to the destination.

When the autonomous mobile unit 10 has completed moving to the destination, the control unit 15 transmits a predetermined move completion notification to the management device 30.

When the control unit 15 has received a lock instruction from the management device 30, the control unit 15 locks the luggage compartment 20. When the control unit 15 has received an unlock instruction from the management device 30, the control unit 15 unlocks the luggage compartment 20. When the control unit 15 has received an information output instruction from the management device 30, the control unit 15 causes the information output unit 14 to output (display) information about details specified by the information output instruction. When the control unit 15 has received an information output stop instruction from the management device 30, the control unit 15 causes the information output unit 14 to stop outputting information.

When a return instruction has been transmitted from the management device 30 to the control unit 15, the control unit 15 resumes control for causing the autonomous mobile unit 10 to travel along the route specified by the traveling route information.

Hereinafter, the configuration and functions of the management device 30 will be described together with a method of using the transport system.

The management device 30 (FIG. 1) is a web server that a computer having a web browser function is able to access. The management device 30 includes a user database (DB) 31, a request management DB 32, and a mobile unit management DB 33.

The transport system according to the present embodiment is configured as a system that requires user registration to use the system. The user DB 31 is a database that stores authentication information (user name and password), name, address, e-mail address, and the like, of each user who has completed user registration.

The mobile unit management DB 33 is a database that stores assignment information and current locations for a last certain period of time for each autonomous mobile unit 10. The assignment information indicates whether a transport request is assigned to the autonomous mobile unit 10.

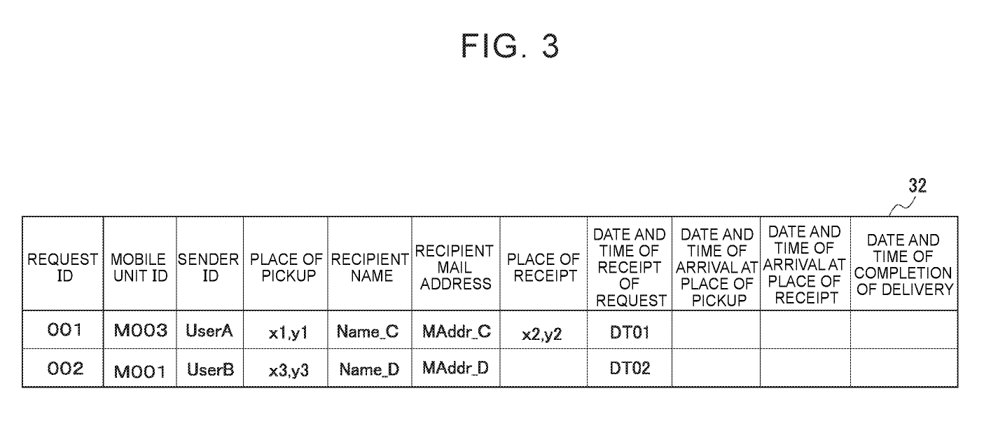

The request management DB 32 is a database for managing the progress, and the like, of an accepted transport request. Although described in detail later, the request management DB 32 has a configuration shown in FIG. 3.

A user (hereinafter, referred to as sender) who wants to transfer a package to a recipient with the use of the transport system logs into the management device 30 with user's own authentication information, and causes a transport request page to be displayed on a sender terminal (mobile terminal or non-mobile terminal). The transport request page is a web page for a transport request. This transport request page allows specification of a place of pickup and a place of receipt on a map and input of recipient name and recipient e-mail address. The sender sets at least a place of pickup, recipient name and recipient e-mail address, and then operates a transmission button on the transport request page. The management device 30 provides the transport request page to the sender terminal when there is one or more autonomous mobile units 10 to which no transport request is assigned (when assignment information for one or more autonomous mobile units 10 in the mobile unit management DB 33 indicates that no transport request is assigned). When there is no autonomous mobile unit 10 to which no transport request is assigned, the management device 30 provides the sender terminal with a predetermined web page to inform the sender that the management device 30 is currently not able to accept a transport request.

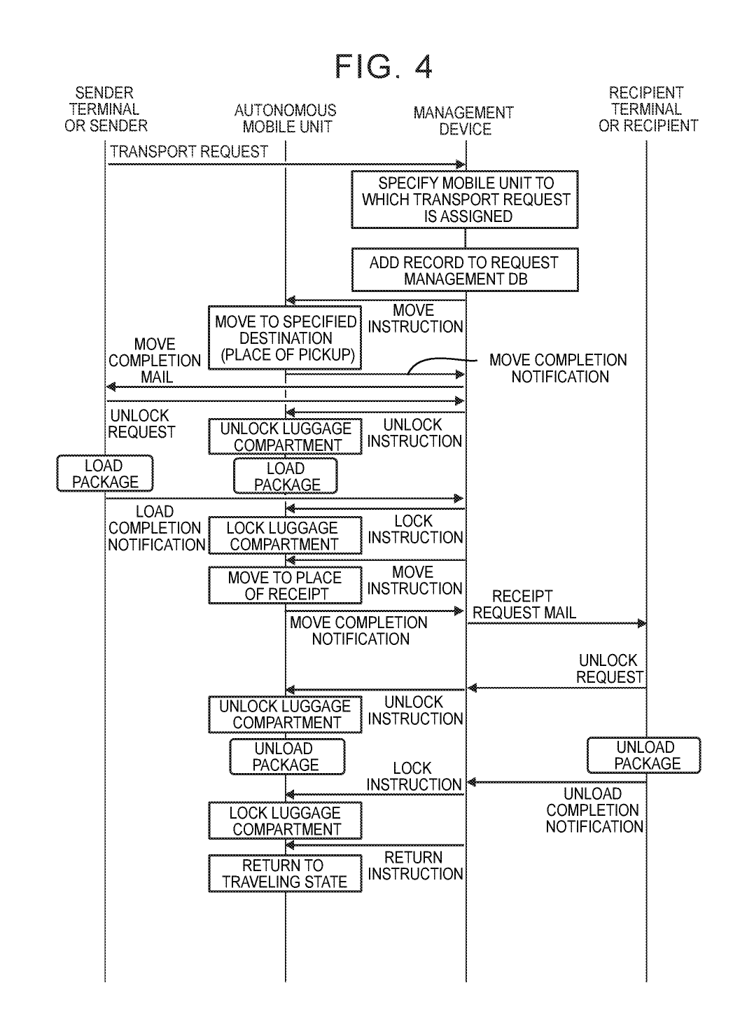

As the transmission button on the transport request page is operated, a transport request containing pieces of information set by the sender is transmitted from the sender terminal to the management device 30 as shown in FIG. 4. FIG. 4 is a sequence diagram of the transport system in the case where the sender has also specified a place of receipt. The operations of the transport system in the case where the sender has not specified a place of receipt will be described after the operations of the transport system in the case where the sender has also specified a place of receipt are described.

As the management device 30 receives a transport request, the management device 30 determines the autonomous mobile unit 10 to which the current transport request is assigned by consulting the mobile unit management DB 33. More specifically, the management device 30 consults the mobile unit management DB 33, and finds the autonomous mobile unit 10 of which the current location is closest to the place of pickup specified by the sender from among the autonomous mobile units 10 to which no transport work is assigned. The management device 30 determines the found autonomous mobile unit 10 as the autonomous mobile unit 10 to which the current transport request is assigned.

As the management device 30 completes determining the autonomous mobile unit 10 to which the transport request is assigned, the management device 30 changes the assignment information in the mobile unit management DB 33 for the determined autonomous mobile unit 10 to information that indicates that the transport request is assigned to the autonomous mobile unit 10.

The management device 30 adds a record associated with the transport request accepted this time to the request management DB 32. More specifically, the management device 30 adds a record having the following pieces of information to the request management DB 32 (FIG. 3).

Request ID: a value incremented by one from the maximum value of the request ID in the request management DB 32 before a record is added
Mobile unit ID: the ID (identification information) of the autonomous mobile unit 10 to which the current transport request is assigned
Sender ID: the ID of the sender in the management device 30
Place of pickup, recipient name, recipient mail address, and place of receipt: values set by the sender
Date and time of receipt of request: present date and time
Date and time of completion of delivery, date and time of arrival at place of receipt, and date and time of arrival at place of pickup: Null

The management device 30 transmits a move instruction to the autonomous mobile unit 10 to which the current transport request is assigned (hereinafter, simply referred to as autonomous mobile unit 10). The move instruction specifies the place of pickup as a destination. A communication protocol for transmitting the move instruction to the autonomous mobile unit 10 may be any protocol. For example, a response to a notification about the current location from the autonomous mobile unit 10 may include a move instruction.

As already described above, when the control unit 15 of the autonomous mobile unit 10 has received the move instruction, the control unit 15 controls the drive unit 16 such that the autonomous mobile unit 10 reaches the destination specified by the move instruction. When the autonomous mobile unit 10 has completed moving to the destination, the control unit 15 transmits a move completion notification to the management device 30.

When the move completion notification has been transmitted from the autonomous mobile unit 10 instructed to move to the place of pickup, the management device 30 transmits a move completion mail to the sender that the autonomous mobile unit 10 has completed moving to the place of pickup. Although not shown in FIG. 4, the management device 30 executes a process of setting a present date and time as date and time of arrival at place of pickup to a record in which the mobile unit ID of the autonomous mobile unit 10 that is the source of the move completion notification is set in the request management DB 32, and also executes a process of causing the information output unit 14 of the autonomous mobile unit 10 to display a message informing that the luggage compartment 20 is allowed to be unlocked through an unlock request page by transmitting an information output instruction.

As the sender receives the move completion mail, the sender goes to a place where the autonomous mobile unit 10 is stopped while carrying a package and the portable sender terminal, and causes the sender terminal to display an unlock request page by accessing the management device 30 with the use of the sender terminal. This unlock request page contains an unlock request item and a load completion notification item. As the unlock request item is operated, an unlock request is transmitted to the management device 30. As the load completion notification item is operated, a load completion notification is transmitted to the management device 30.

The sender initially operates the unlock request item on the unlock request page. As the management device 30 receives the unlock request transmitted through operation of the unlock request item, the management device 30 transmits an unlock instruction to the autonomous mobile unit 10. As already described above, as the control unit 15 receives the unlock instruction, the control unit 15 unlocks the luggage compartment 20. Therefore, the sender opens the door of the luggage compartment 20, loads the package into the luggage compartment 20, and then operates the load completion notification item.

As the management device 30 receives the load completion notification that is transmitted through operation of the load completion notification item, the management device 30 causes the control unit 15 of the autonomous mobile unit 10 to lock the luggage compartment 20 by transmitting a lock instruction. Although not shown in FIG. 4, as the management device 30 receives the load completion notification, the management device 30 causes the information output unit 14 to stop outputting information (displaying a message) by transmitting an information output stop instruction.

Subsequently, the management device 30 transmits a move instruction to the autonomous mobile unit 10. The move instruction is an instruction to move to a place of receipt specified by the sender.

As the move instruction is transmitted, the control unit 15 of the autonomous mobile unit 10 causes the autonomous mobile unit 10 to move to the place of receipt, and then transmits a move completion notification to the management device 30.

When the move completion notification has been transmitted from the autonomous mobile unit 10 instructed to move to the place of receipt, the management device 30 transmits a receipt request mail to the recipient. The receipt request mail contains a message making a request to receive the package, a message informing that the luggage compartment 20 is allowed to be unlocked through a second unlock request page that is provided by the management device 30, and the like. Before the management device 30 transmits the receipt request mail, the management device 30 determines whether there is a registered user of which the name and e-mail address stored in the user DB 31 coincide with the name and e-mail address of the recipient specified by the sender. That is, the management device 30 determines whether the recipient is a registered user. When the recipient is not a registered user, the management device 30 issues temporary authentication information that allows access to only the second unlock request page provided by the management device 30, and transmits a receipt request mail containing the issued temporary authentication information.

As the move completion notification has been transmitted to the management device 30 from the autonomous mobile unit 10 instructed to move to the place of receipt, the management device 30 executes a process of setting a present date and time as date and time of arrival at place of receipt to the record in which the mobile unit ID of the autonomous mobile unit 10 that is the source of the move completion notification is set in the request management DB 32, and also executes a process of causing the information output unit 14 of the autonomous mobile unit 10 to display a message informing that the luggage compartment 20 is allowed to be unlocked through the second unlock request page by transmitting an information output instruction.

As the recipient receives the receipt request mail, the recipient goes to a place where the autonomous mobile unit 10 is stopped while carrying a portable recipient terminal, and causes the recipient terminal to display the second unlock request page by accessing the management device 30 with recipient's own authentication information or the above-described temporary authentication information. This second unlock request page contains an unlock request item and an unload completion notification item. As the unlock request item is operated, an unlock request is transmitted to the management device 30. As the unload completion notification item is operated, an unload completion notification is transmitted to the management device 30.

The recipient initially operates the unlock request item on the second unlock request page. As the management device 30 receives the unlock request, the management device 30 transmits an unlock instruction to the autonomous mobile unit 10, so the luggage compartment 20 is unlocked by the control unit 15. The recipient opens the door of the luggage compartment 20, unloads the package, and then operates the unload completion notification item.

As the management device 30 receives the unload completion notification that is transmitted through operation of the unload completion notification item, the management device 30 causes the control unit 15 of the autonomous mobile unit 10 to lock the luggage compartment 20 by transmitting a lock instruction. The management device 30 further executes a process of setting a present date and time as date and time of completion of delivery to the record in which the mobile unit ID of the autonomous mobile unit 10 that is the source of the unload completion notification is set in the request management DB 32, and a process of causing the information output unit 14 to stop outputting information (displaying a message) by transmitting an information output stop instruction. When the management device 30 has issued temporary authentication information, the management device 30 also executes a process of invalidating the temporary authentication information.

After that, the management device 30 causes the autonomous mobile unit 10 to return to a normal state (state where the autonomous mobile unit 10 travels along a route specified by the traveling route information) by transmitting a return instruction.

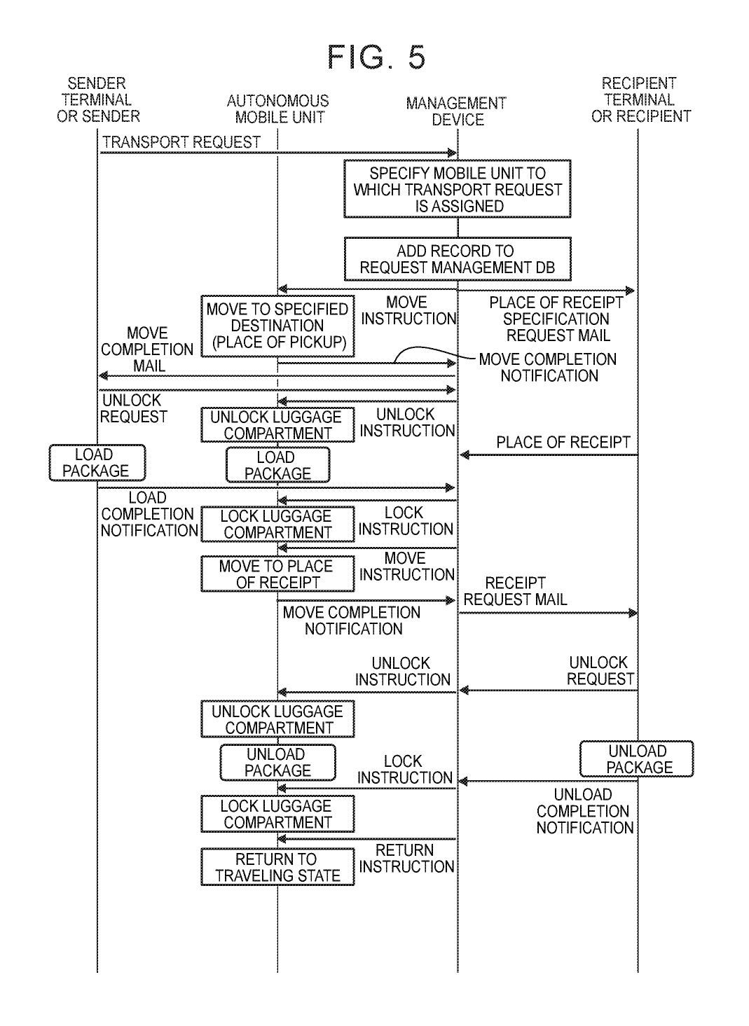

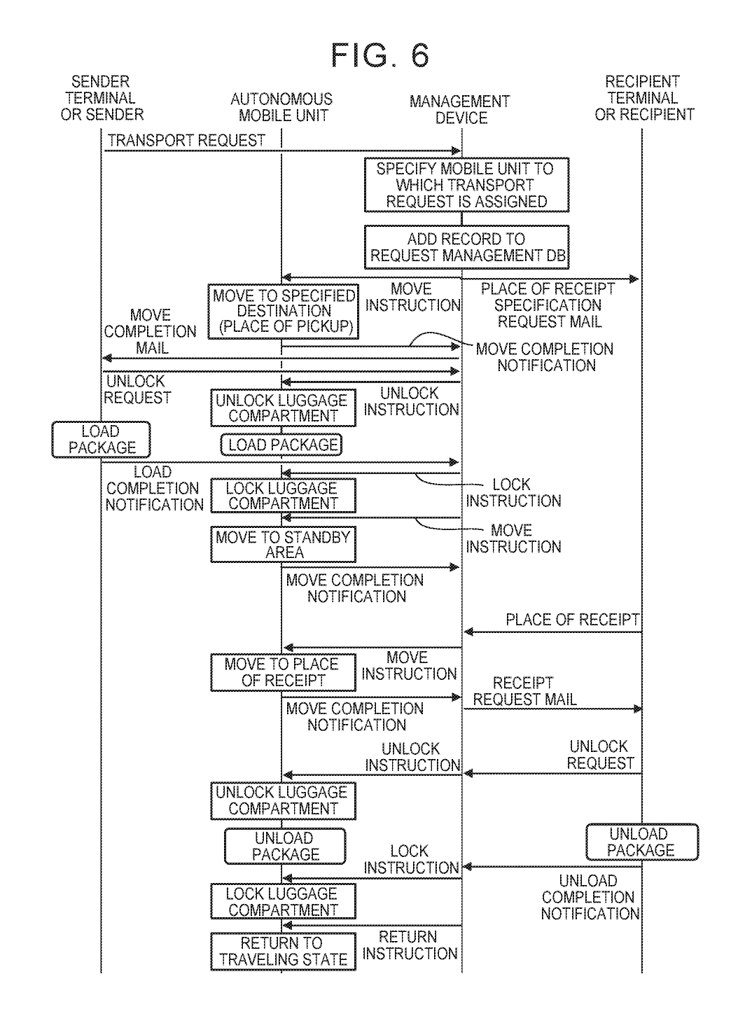

Hereinafter, the operations of the transport system in the case where the sender has not specified a place of receipt will be described. In this case, as shown in FIG. 5 and FIG. 6, when the management device 30 transmits a move instruction to the autonomous mobile unit 10 to move to a place of pickup, the management device 30 transmits a place of receipt specification request mail to the recipient. The place of receipt specification request mail makes a request of the recipient to specify a place of receipt through a place of receipt specification page provided by the management device 30. At the time when the management device 30 transmits this place of receipt specification request mail, as well as when the management device 30 transmits a receipt request mail, the management device 30 incorporates temporary authentication information into a mail to be transmitted, when the recipient is not a registered user.

As shown in FIG. 5, when the recipient has specified a place of receipt by accessing the place of receipt specification page before the management device 30 receives a load completion notification, the operations of units after an exchange of the load completion notification are the same as those in the case where the sender has specified a place of receipt as well (FIG. 4).

On the other hand, when the recipient has not specified a place of receipt by accessing the place of receipt specification page before the management device 30 receives a load completion notification, the management device 30 does not transmit a move instruction to the autonomous mobile unit 10 to move to a place of receipt, and transmits a move instruction to the autonomous mobile unit 10 to move to a standby area as shown in FIG. 6. At this time, a move instruction to be transmitted is a move instruction to a standby area closest to the current location of the autonomous mobile unit 10. Then, when a place of receipt has been specified by the recipient, the management device 30 transmits a move instruction to the autonomous mobile unit 10 to move to the place of receipt.

As described above, with the transport system according to the present embodiment, when a sender of a package specifies a desired place as a place of pickup, the autonomous mobile unit 10 reaches the place of pickup. When the sender loads the package into the luggage compartment 20 of the autonomous mobile unit 10 that has arrived at the place of pickup, and transmits a lock request with the use of a mobile terminal, or the like, the autonomous mobile unit 10 moves to a place of receipt specified by the sender or a recipient. During moving, the luggage compartment 20 of the autonomous mobile unit 10 is locked, and the transport system has such a configuration that locking of the luggage compartment 20 is released when the recipient has made a request to unlock the luggage compartment 20 (when the management device 30 has received an unlock request transmitted by the recipient). Therefore, with the transport system according to the present embodiment, it is possible to realize an environment that, in a form that neither a problem, such as theft, replacement, and damage, occurs on a package nor a package is unloaded from the luggage compartment 20 by a person other than a recipient during transport, a sender is allowed to ship a package at a desired place and the recipient is allowed to receive a package at a place of receipt specified by the sender or a place of receipt specified by the recipient.

### Second Embodiment

Hereinafter, the configuration and operations of a transport system according to a second embodiment of the disclosure will be described focusing on differences from the above-described transport system according to the first embodiment. For the sake of convenience of description, in the following description, the management device 30, each autonomous mobile unit 10, and the control unit 15 of the autonomous mobile unit 10 in the transport system according to the Nth (N=1 or 2) embodiment are respectively referred to as the Nth management device 30, each Nth autonomous mobile unit 10, and the Nth control unit 15.

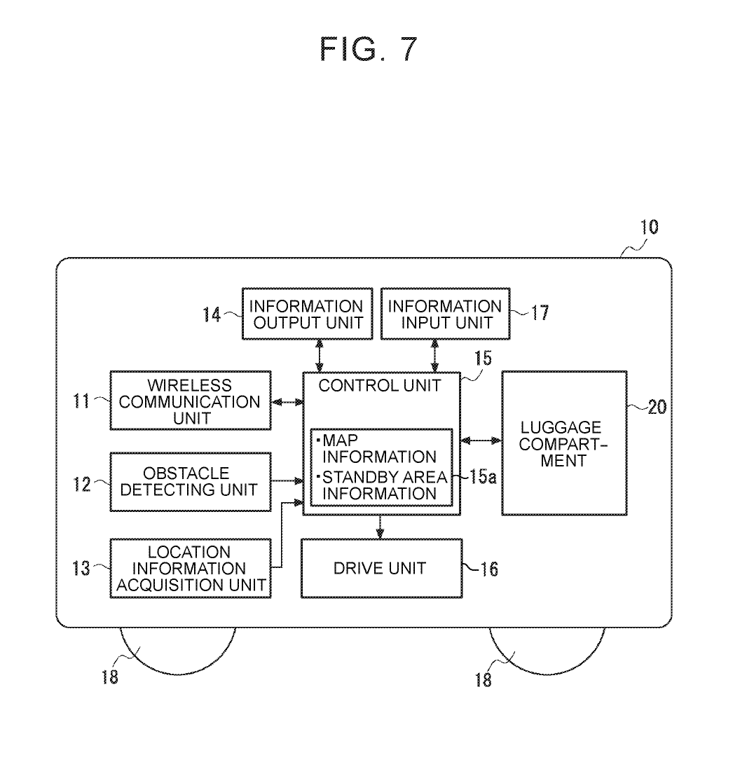

The transport system according to the second embodiment of the disclosure is a system in which a second autonomous mobile unit configured as shown in FIG. 7 is employed in place of the above-described first autonomous mobile unit 10 (FIG. 2) and the first management device 30 is modified into a second management device 30 that executes operations slightly different from the above-described operations.

As is apparent from FIG. 7, the second autonomous mobile unit 10 is a device (autonomous mobile vehicle) that an information input unit 17 is added to the first autonomous mobile unit 10 as for its hardware. The information input unit 17 according to the present embodiment is a unit including a push button switch for inputting a numeric value, a push button switch for inputting a cancellation instruction, a push button switch corresponding to an enter key, and a liquid crystal display that displays input information. However, the information input unit 17 may be any unit to which information is allowed to be input.

An instruction that the second management device 30 provides to the second control unit 15 includes a move instruction, a lock instruction, an information output instruction, an information output stop instruction, and a return instruction. The operations of the second control unit 15 in response to the move instruction, the information output instruction, the information output stop instruction, and the return instruction are respectively the same as the operations of the first control unit 15 in response to the move instruction, the information output instruction, the information output stop instruction, and the return instruction.

However, the second control unit 15 differs from the first control unit 15 in the following points.

A storage area for an unlock key is reserved in the nonvolatile memory 15a of the second control unit 15. The second control unit 15 does not unlock the luggage compartment 20 when the unlock instruction is transmitted to the second control unit 15. The second control unit 15 unlocks the luggage compartment 20 when the same information as the unlock key stored in the nonvolatile memory 15a has been input to the information input unit 17. The second control unit 15 accepts a lock instruction containing a specified unlock key and a lock instruction not containing a specified unlock key. As the second control unit 15 receives a lock instruction containing a specified unlock key, the second control unit 15 locks the luggage compartment 20. The second control unit 15 updates (overwrites) the unlock key on the nonvolatile memory 15a with an unlock key specified by the lock instruction. Thus, the second control unit 15 shifts into a state where the second control unit 15 unlocks the luggage compartment 20 when the newly specified unlock key has been input to the information input unit 17. As the second control unit 15 receives a lock instruction not containing a specified unlock key, the second control unit 15 simply locks the luggage compartment 20. That is, the second control unit 15 maintains a state where the second control unit 15 unlocks the luggage compartment 20 with the same unlock key as before.

The second management device 30 is basically a device that operates similarly to the first management device 30. An effective unlock key (unlock key with which the second control unit 15 unlocks the luggage compartment 20 as the unlock key is input to the information input unit 17) at that point in time for each autonomous mobile unit 10 is also stored in the mobile unit management DB 33 in the second management device 30.

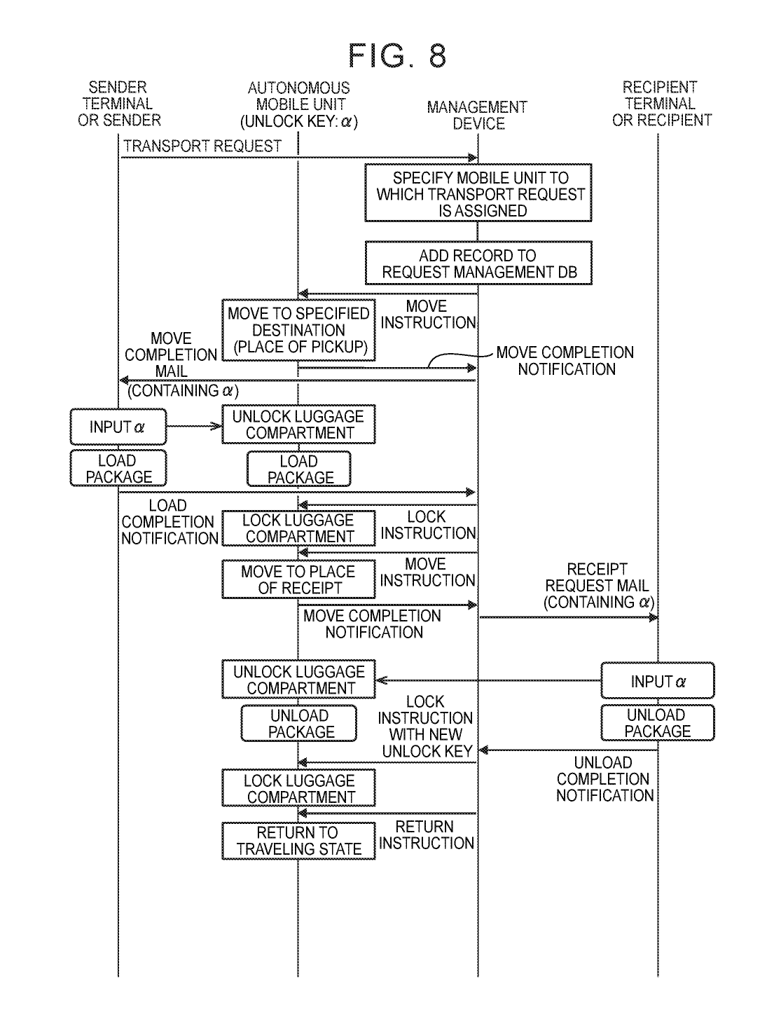

As schematically shown in FIG. 8, when the autonomous mobile unit 10 has completed moving to a place of pickup, the second management device 30 transmits a move completion mail, containing an effective unlock key at that point in time, to the sender. The second management device 30 also incorporates an effective unlock key at that point in time into a receipt request mail that is transmitted to the recipient. FIG. 8 is a sequence diagram of the transport system according to the second embodiment in the case where a place of receipt has been specified by the sender. When a place of receipt has not been specified by the sender, the second management device 30, as well as the first management device 30 (see FIG. 5 and FIG. 6), transmits a place of receipt specification request mail to the recipient.

As shown in FIG. 8, when an unload completion notification has been transmitted from a recipient terminal to the second management device 30, the second management device 30 generates a new unlock key different in value from the unlock key until then, and transmits a lock instruction containing the generated specified unlock key to the autonomous mobile unit 10.

As is apparent from the above description, the transport system according to the present embodiment is modified from the above-described transport system according to the first embodiment such that the luggage compartment 20 is allowed to be unlocked (locking of the luggage compartment 20 is allowed to be released) by inputting an unlock key to the information input unit 17. Therefore, with the transport system according to the present embodiment as well, it is possible to realize an environment that, in a form that neither a problem, such as theft, replacement, and damage, occurs on a package nor a package is unloaded from the luggage compartment 20 by a person other than a recipient during transport, a sender is allowed to ship a package at a desired place and the recipient is allowed to receive a package at a place of receipt specified by the sender or a place of receipt specified by the recipient.

### Alternative Embodiments

Each of the transport systems according to the above-described embodiments may be modified into various forms. For example, each of the transport systems according to the embodiments may be modified into a system in which each autonomous mobile unit 10 is a device that is able to fly autonomously (so-called drone). The transport system according to the second embodiment may be modified into a system in which each autonomous mobile unit 10 includes the information input unit 17 that is able to carry out IR communication, short-range wireless communication, near-field wireless communication, acoustic communication, reading of an identification code (such as a bar code and a QR code (registered trademark of Denso Wave Incorporated)), or the like, and information that enables transmission of an unlock key with the use of the IR communication, short-range wireless communication function, near-field wireless communication function, acoustic communication function, identification code display function, or the like, of a mobile terminal is transmitted from the management device 30 to a sender terminal or a recipient terminal.

The control unit 15 of each autonomous mobile unit 10 may be modified into a control unit configured to lock the luggage compartment 20 by determining that loading of a package has been completed when the door of the luggage compartment 20 has been once opened and then closed. Thus, it is not required to transmit a load or unload completion notification from a sender or recipient terminal. The management device 30 of the transport system according to the second embodiment may be modified into a device configured to separately provide a lock instruction and an instruction to update an unlock key. The transport system according to the second embodiment may be modified into a system in which each autonomous mobile unit 10 generates an unlock key at the time of locking after loading of a package and provides the unlock key to the management device 30 and then the unlock key is provided from the management device 30 to a recipient.

Of course, the specific hardware configuration of each autonomous mobile unit 10 may be different from the above-described one, and the specific operation details of the control unit 15 and management device 30 may be different from the above-described ones.

What is claimed is:

1. A transport system comprising:
an autonomous mobile unit; and
a management device,
the autonomous mobile unit including
a lockable and unlockable luggage compartment,
a drive unit configured to move the autonomous mobile unit,
a wireless communication unit configured to carry out wireless communication, and
a control unit configured to
communicate with another device via the wireless communication unit,
control the drive unit such that the autonomous mobile unit reaches a destination specified by a move instruction, when the control unit has received, from the management device, the move instruction containing the destination,
lock the luggage compartment, when the control unit has received a lock instruction from the management device, and
unlock the luggage compartment, when the control unit has received an unlock instruction from the management device, and
the management device including
a user interface unit configured to allow a client requesting transport of a package to specify a recipient of the package and a place of pickup where pickup of the package is performed,
a first move instruction transmission unit configured to transmit, to the autonomous mobile unit, the move instruction containing the place of pickup specified by the client as the destination,
a lock instruction transmission unit configured to, when lock request information transmitted by the client has been received by the management device, transmit the lock instruction to the autonomous mobile unit,
a second move instruction transmission unit configured to transmit, to the autonomous mobile unit, the move instruction containing a place of receipt where receipt of the package is performed specified by any one of the client and the recipient as the destination, and
an unlock instruction transmission unit configured to, when unlock request information transmitted by the recipient has been received by the management device, transmit the unlock instruction to the autonomous mobile unit.

2. The transport system according to claim 1, wherein, when the second move instruction transmission unit is configured to transmit, to the autonomous mobile unit, the move instruction containing the place of receipt specified by the client as the destination, the user interface unit is configured to allow the client to specify the recipient of the package, the place of pickup, and the place of receipt.

3. The transport system according to claim 1, wherein, when the second move instruction transmission unit is configured to transmit, to the autonomous mobile unit, the move instruction containing the place of receipt specified by the recipient as the destination, the management device further includes a second user interface unit configured to allow the recipient to specify the place of receipt.

4. A transport system comprising:
an autonomous mobile unit; and
a management device,
the autonomous mobile unit including
a lockable and unlockable luggage compartment,
a drive unit configured to move the autonomous mobile unit,
a wireless communication unit configured to carry out wireless communication,
an information input unit configured to receive input of information, and
a control unit configured to
communicate with another device via the wireless communication unit,
control the drive unit such that the autonomous mobile unit reaches a destination specified by a move instruction, when the control unit has received, from the management device, the move instruction containing the destination,
lock the luggage compartment and transmit lock release information to the management device, when the control unit determines that loading of a package into the luggage compartment has been completed, and
unlock the luggage compartment when the lock release information has been input to the information input unit, and
the management device including
a user interface unit configured to allow a client requesting transport of the package to specify a recipient of the package and a place of pickup where pickup of the package is performed,
a first move instruction transmission unit configured to transmit, to the autonomous mobile unit, the move instruction containing the place of pickup specified by the client as the destination, and
a second move instruction transmission unit configured to,
provide the lock release information to the recipient after the lock release information has been received from the autonomous mobile unit, and
transmit, to the autonomous mobile unit, the move instruction containing a place of receipt where receipt of the package is performed specified by any one of the client and the recipient as the destination.

5. The transport system according to claim 4, wherein the control unit of the autonomous mobile unit is configured to, when predetermined information has been input to the information input unit, determine that loading of the package into the luggage compartment has been completed.

6. The transport system according to claim 4, wherein the control unit is configured to, when a door of the luggage compartment has been once opened and then closed, determine that loading of the package into the luggage compartment has been completed.

7. A transport system comprising:
an autonomous mobile unit; and
a management device,
the autonomous mobile unit including
a lockable and unlockable luggage compartment,
a drive unit configured to move the autonomous mobile unit,
a wireless communication unit configured to carry out wireless communication,
an information input unit configured to receive input of information, and
a control unit including a storage unit for storing lock release information, the control unit being configured to
communicate with another device via the wireless communication unit,
control the drive unit such that the autonomous mobile unit reaches a destination specified by a move instruction when the control unit has received, from the management device, the move instruction containing the destination,
lock the luggage compartment when the control unit determines that loading of a package into the luggage compartment has been completed,
unlock the luggage compartment when the same information as the lock release information in the storage unit has been input to the information input unit,
update first lock release information included in the lock release information in the storage unit with second lock release information included in a predetermined lock release information update instruction and included in the lock release information when the control unit has received the predetermined lock release information update instruction from the management device, and
the management device including
an update instruction unit configured to generate the second lock release information and transmit the lock release information update instruction, the lock release information update instruction containing the second lock release information, to the autonomous mobile unit,
a user interface unit configured to allow a client requesting transport of the package to specify a recipient of the package and a place of pickup where pickup of the package is performed,
a first move instruction transmission unit configured to transmit, to the autonomous mobile unit, the move instruction containing the place of pickup specified by the client as the destination, and
a second move instruction transmission unit configured to
provide the latest second lock release information generated by the update instruction unit to the recipient, and
transmit, to the autonomous mobile unit, the move instruction containing a place of receipt where receipt of the package is performed specified by any one of the client and the recipient as the destination.

8. The transport system according to claim 7, wherein the control unit of the autonomous mobile unit is configured to, when predetermined information has been input to the information input unit, determine that loading of the package into the luggage compartment has been completed.

9. The transport system according to claim 7, wherein the control unit is configured to, when a door of the luggage compartment has been once opened and then closed, determine that loading of the package into the luggage compartment has been completed.

10. A transport method for causing an autonomous mobile unit, the autonomous mobile unit including an electrically lockable and unlockable luggage compartment, to transport a package, the transport method comprising:
allowing, by one or more computers, a client requesting transport of the package by the autonomous mobile unit to specify a recipient of the package and a place of pickup where pickup of the package is performed;
moving, by the one or more computers, the autonomous mobile unit to the place of pickup specified by the client;
locking, by the one or more computers, the luggage compartment, when the one or more computers determines that loading of the package into the luggage compartment of the autonomous mobile unit moved to the place of pickup has been completed;
moving, by the one or more computers, the autonomous mobile unit of which the luggage compartment has been locked to a place of receipt where receipt of the package is performed specified by any one of the client and the recipient; and
unlocking, by the one or more computers, the luggage compartment of the autonomous mobile unit moved to the place of receipt, when an unlock instruction has been input by the recipient.

11. The transport method according to claim 10, wherein, locking, by the one or more computers, the luggage compartment, when the one or more computers determines that loading of the package into the luggage compartment has been completed includes determining that loading of the package into the luggage compartment has been completed when a door of the luggage compartment has been once opened and then closed.

12. The transport method according to claim 10, wherein, locking, by the one or more computers, the luggage compartment, when the one or more computers determines that loading of the package into the luggage compartment has been completed includes determining that loading of the package into the luggage compartment has been completed when a lock instruction has been input by the client.
